(19) United States
(12) Patent Application Publication
(10) Pub. No.: US 2020/0278771 A1
(43) Pub. Date: Sep. 3, 2020

(54) MULTI-SIZE TOUCH SENSOR

(71) Applicant: 3M INNOVATIVE PROPERTIES COMPANY

(72) Inventors: Kenneth J. Keefer, Westford, MA (US); Mark E. Flanzer, Acton, MA (US); Keith B. Loop, Franklin, MA (US)

(21) Appl. No.: 15/780,666

(22) PCT Filed: Jan. 17, 2017
(86) PCT No.: PCT/US2017/013721

§ 371 Date: Jun. 1, 2018

Related U.S. Application Data
(60) Provisional application No. 62/281,300, filed on Jan. 21, 2016.

(51) Int. Cl. G06F 3/044

(52) U.S. Cl. CPC G06F 3/0445; G06F 2203/04103; G06F 2203/04102; G06F 3/0446

(57) ABSTRACT

A capacitive touch sensor includes a touch sensitive viewing area with a border area surrounding the touch sensitive viewing area and having an outermost polygonal perimeter comprising a plurality of sides and vertices. A plurality of spaced apart electrically conductive first electrodes is disposed in the touch sensitive viewing area and extends along a first direction. A plurality of spaced apart electrically conductive second electrodes is disposed in the touch sensitive viewing area and extends along a different second direction. Electrically conductive bus lines are disposed in the border area for electrically coupling the pluralities of the first and second electrodes to a controller. At least one first alignment feature is disposed within the border area near each of at least three vertices of the polygonal perimeter for aligning the touch sensor to a substrate. At least one second alignment feature is disposed within the border area near at least one side of the polygonal perimeter and away from the vertices corresponding to the side.

### TECHNICAL FIELD

This disclosure relates generally to touch sensors, and to related processes and systems.

### BACKGROUND

Touch sensitive devices allow a user to conveniently interface with electronic systems and displays by reducing or eliminating the need for mechanical buttons, keypads, keyboards, and pointing devices. For example, a user can carry out a complicated sequence of instructions by simply touching an on-display touch screen at a location identified by an icon.

Projected capacitive touch sensing devices have been found to work well in a number of applications. In many touch sensitive devices, the input is sensed when a conductive object in the sensor is capacitively coupled to a conductive touch implement such as a user's finger. Generally, whenever two electrically conductive members come into proximity with one another without actually touching, a capacitance is formed therebetween. In the case of a capacitive touch sensitive device, as an object such as a finger approaches the touch sensing surface, a capacitance forms between the object and the sensing points in close proximity to the object. By detecting changes in capacitance at the sensing point, the sensing circuit can determine the location of the touch.

### BRIEF SUMMARY

According to some embodiments, a capacitive touch sensor includes a plurality of spaced apart electrically conductive first electrodes extending along a first direction and a plurality of spaced apart electrically conductive second electrodes extending along a different second direction. The touch sensor includes plurality of electrically conductive bus lines. Each bus line corresponds to a first or second electrode. A first end of each bus line terminates at a connection region at a periphery of the touch sensor for connection to a controller. An opposite second end of each bus line, except for at least one bus line, terminates at and makes contact with a corresponding first or second electrode. The opposite second end of the at least one bus line terminates near, but does not make contact with, a longitudinal end of a corresponding first or second electrode.

According to some embodiments, a capacitive touch sensor comprises a flexible substrate having first and second edges extending along different respective first and second directions. A plurality of spaced apart electrically conductive first electrodes is disposed on the flexible substrate and extends longitudinally along the first direction. The first electrode nearest the first edge of the substrate is narrower than the rest of the first electrodes and extends widthwise to the first edge. A plurality of spaced apart electrically conductive second electrodes is disposed on the flexible substrate and extends longitudinally along the second direction.

In some embodiments, a capacitive touch sensor includes a touch sensitive viewing area with a border area surrounding the touch sensitive viewing area and having an outermost polygonal perimeter comprising a plurality of sides and vertices. A plurality of spaced apart electrically conductive first electrodes is disposed in the touch sensitive viewing area and extends along a first direction. A plurality of spaced apart electrically conductive second electrodes is disposed in the touch sensitive viewing area and extends along a different second direction. A plurality of electrically conductive bus lines is disposed in the border area for electrically coupling the pluralities of the first and second electrodes to a controller.

At least one first alignment feature is disposed within the border area near each of at least three vertices of the polygonal perimeter for aligning the touch sensor to a substrate. At least one second alignment feature is disposed within the border area near each of at least one side of the polygonal perimeter and away from the vertices corresponding to the side.

In accordance with some embodiments, a capacitive touch sensitive device includes a touch sensor that comprises a plurality of spaced apart electrically conductive first electrodes extending along a first direction. A plurality of electrically conductive first bus lines electrically connect a first end of each first electrode to a first connection region at a periphery of the touch sensor for connection to a controller. A plurality of electrically conductive third bus lines electrically connect an opposite second end of each first electrode to a different third connection region at the periphery of the touch sensor for connection to a controller. The touch sensitive device includes a flexible circuit connected to the first, but not the third, connection region. The touch sensitive device is configured to detect a location of a touch applied to the touch sensor by detecting a change in a coupling capacitance near the touch location.

Some embodiments are directed to a method of making a rectangular smaller touch sensor from a rectangular larger touch sensor. A first cutline extending across a viewing area of the larger touch sensor and orthogonally intersecting a first side of the larger touch sensor at a first cut location is determined. The first side terminates at first and second vertices of the larger touch sensor. A first alignment feature is formed at a first vertex of the larger touch sensor. The first alignment feature is configured to align the larger touch sensor to a larger substrate. A second alignment feature is formed near the first cut location opposite the first alignment feature. The larger sensor is cut along the first cutline into multiple cut portions. The cut portion comprising the second alignment feature is formed into a smaller touch sensor. The second alignment feature is at a vertex of the smaller touch sensor and configured to align the smaller touch sensor with a smaller substrate.

These and other aspects of the present application will be apparent from the detailed description below. In no event, however, should the above summaries be construed as limitations on the claimed subject matter, which subject matter is defined solely by the attached claims.

### BRIEF DESCRIPTION OF THE DRAWINGS

FIG. 1 is a top view of a full size touch sensor that includes alignment features in accordance with some embodiments;

FIG. 2 is a cross sectional diagram showing alignment of the touch sensor of FIG. 1 with a substrate in accordance with some embodiments;

FIG. 3 is a flow diagram illustrating processes of making a rectangular smaller touch sensor from a rectangular larger touch sensor in accordance with some embodiments;

FIG. 4A depicts a top view of a cut down touch sensor in accordance with some embodiments;

FIG. 4B is a more detailed view of a portion of the touch sensor of FIG. 4A;

FIG. 5 illustrates first and second electrodes comprising a metal mesh in accordance with some embodiments; and

FIG. 6 depicts a top view of a cut down touch sensor in accordance with some embodiments.

The figures are not necessarily to scale. Like numbers used in the figures refer to like components. However, it will be understood that the use of a number to refer to a component in a given figure is not intended to limit the component in another figure labeled with the same number.

### DESCRIPTION OF ILLUSTRATIVE EMBODIMENTS

A classical capacitive touch sensor is designed using a discrete film design (e.g., photomask) that is specifically designed for a touch sensor of a particular size. Each photomask may be used to create a large roll of images, which are singulated during the manufacturing process into several touch sensors of the same size and shape. Since this discrete film design typically precludes it from being used on multiple different sized touch sensors, a different roll of images is required for each different sized touch sensor.

It may be more cost effective to use a single photomask or fewer photomasks to fabricate multiple different sized touch sensors. Embodiments disclosed herein disclose a multi-size touch sensor that incorporates features that allow one “full size” touch sensor film to be used to produce a finished cut down touch sensor of a different size (e.g., a 24″ film design maybe cut down to make a 23″ or 21″ or 18″ touch sensor, etc.). The approaches disclosed herein reduce tooling costs associated with producing the one or more photomasks used to make the multi-size touch sensor, simplify inventory management (fewer master touch sensor rolls to manage), and provide other useful characteristics. According to some embodiments, the full size touch sensor includes alignment features and/or other features that provide for producing the cut down touch sensors. According to some embodiments, the cut down touch sensors include features that are not present in the full size touch sensor.

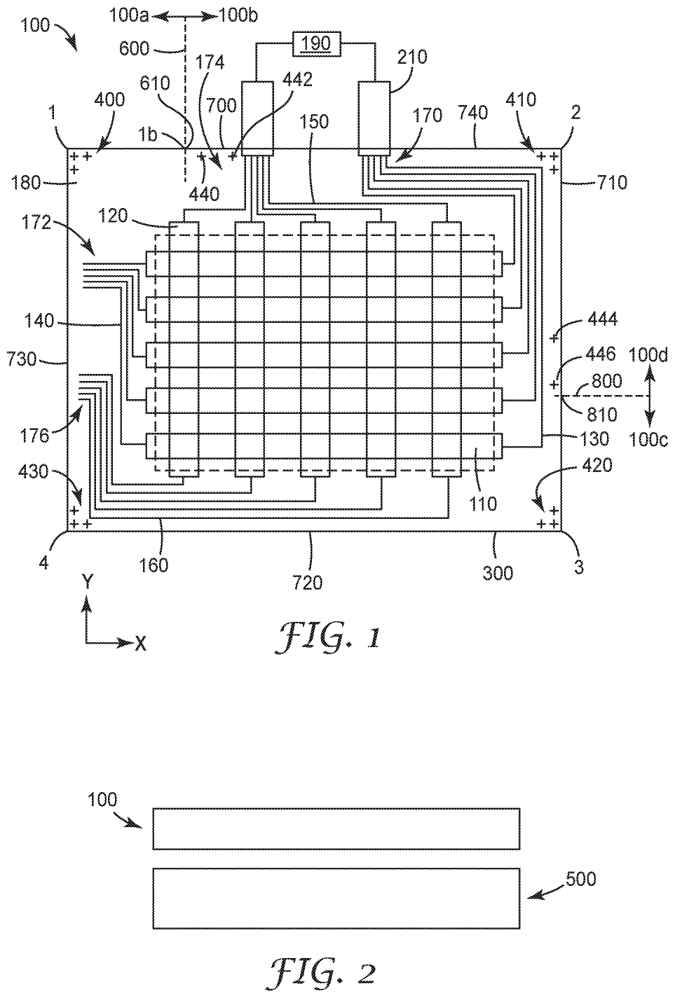

FIG. 1 is a top view of a full size capacitive touch sensor 100 that can be cut down to produce touch sensors of multiple smaller sizes. The touch sensor 100 has a touch sensitive viewing area 115 with a periphery 180 (also referred to as a “border area”) surrounding the touch sensitive viewing area 115. The touch sensor 100 has an outermost polygonal perimeter 740 comprising a plurality of sides 700, 710, 720, 730 and vertices 1, 2, 3, 4. In the example shown, the touch sensor 100 is rectangular but it will be appreciated that touch sensor shapes other than rectangular that include more or fewer sides and vertices are also possible.

The touch sensor 100 includes a plurality of spaced apart electrically conductive first electrodes 110 disposed in the touch sensitive viewing area 115 and extending along a first direction, which is designated as the x direction in FIG. 1. The touch sensor 100 includes a plurality of spaced apart electrically conductive second electrodes 120 disposed in the touch sensitive viewing area 115 and extending along a different second direction, which is designated as the y direction in FIG. 1. In some embodiments, the first 110 and/or second touch sensitive electrodes 120 may be optically transparent and/or may comprise a metallic grid.

The first and second touch sensitive electrodes 110, 120 are coupled to a plurality of electrically conductive bus lines 130, 140, 150, 160 disposed in the periphery 180 of the touch sensor 100. The electrically conductive bus lines 130, 140, 150, 160 are configured to couple the first and second electrodes 110, 120 to a controller 190. The controller 190 is configured to determine the location of a touch on the touch sensor 100 based on detected changes in capacitance sensed by the first and second electrodes 110, 120.

The touch sensor 100 includes multiple sets of alignment features (also referred to herein as “fiducials”) that can be used to fabricate touch sensors of multiple sizes. When a touch sensitive device, such as a touch sensitive display that incorporates the touch sensor 100, is fabricated, the touch sensor 100 is aligned with a substrate 500, as illustrated in the cross section of FIG. 2. Alignment features located on the touch sensor 100 facilitate alignment of the touch sensor 100 with the substrate 500. To accommodate the fabrication of touch sensors of multiple sizes, the full size touch sensor 100 may include multiple sets of alignment features. The touch sensor 100 may include a set of first alignment features 400, 410, 420, 430 respectively disposed at vertices 1, 2, 3, 4, of the touch sensor 100. The first alignment features 400, 410, 420, 430 provide for aligning a touch sensor of a first size, e.g. the full size touch sensor, with a substrate 500 of a touch sensitive display of a first size. In some embodiments, the substrate 500 may be optically transparent, at least in a region corresponding to the touch sensitive viewing area 115 of the touch sensor 100. It will be appreciated that alignment of the touch sensor 100 to the substrate 500 may be accomplished with fewer than four alignment features, e.g., at least one, at least two, or at least three alignment features located respectively at one, two or three of the vertices may adequately provide for alignment of the “full-size” touch sensor to the substrate.

The touch sensor 100 may also include additional sets of alignment features. For example the touch sensor 100 may include one or more sets of second alignment features 440, 442, 444, 446 that provide for aligning a cut down touch sensor of a second size which is less than the full size touch sensor 100 with a substrate of a second size touch sensitive device. For example, the second alignment features 440, 446, 442, 444 allow the full size touch sensor 100 to be cut down to one or more smaller size touch sensors that can be incorporated into smaller sizes of a touch sensitive display.

In the example shown in FIG. 1, the touch sensor 100 includes four first alignment features 400, 410, 420, 430, each first alignment feature 400, 410, 420, 430 respectively disposed near one the four vertices 1, 2, 3, 4 of the polygonal perimeter 740. The touch sensor also includes at least one second alignment feature within the peripheral area and located near the sides of the polygonal perimeter and away from the vertices corresponding to the sides. For example, as shown in FIG. 1, the touch sensor 100 includes second alignment features 440, 442, 444, 446. Second alignment features 440, 442 are disposed near side 700 and away from the vertices 1 and 2. Second alignment features 444, 446 are disposed near side 710 and away from vertices 2 and 3.

The second alignment features 440, 442, 444, 446 provide for alignment of a cut down touch sensor with a substrate, the cut down touch sensor having a size that is less than the full size of the polygonal perimeter 740 of the touch sensor 100.

As shown in FIG. 1, in some embodiments, a first side 700 of the polygonal perimeter 740 has the at least one first alignment feature 400 located near a longitudinal end of the first side 700 and at least one second alignment feature 440 near a cut location 610 on the first side 700. The first side 700 terminates at first 1 and second 2 vertices of the touch sensor 100. The cut location 610 is between the at least one first and second alignment features 400, 440. The touch sensor 100 is adapted to be cut into a smaller size touch sensor along a cut line 600 perpendicular to and intersecting the first side 700 at the cut location 610. The first cut line 600 may extend across the viewing area 115 of the touch sensor 100 in some cases. When the touch sensor 100 is cut along the cut line 600, the touch sensor 100 is divided into first and second cut portions 100a, 100b. The first cut portion 100a comprises the first alignment feature 400 and may be discarded. The second cut portion 100b forms a smaller touch sensor having the second alignment feature 440 near a vertex 1b of the smaller touch sensor 100b. The second alignment feature 440 is adapted for aligning the smaller touch sensor 100b to a substrate, e.g. a smaller substrate.

In some embodiments, a second side 710 of the polygonal perimeter 740 has at least one first alignment feature 420 located near a longitudinal end of the second side 710 and at least one second alignment feature 446 near a cut location 810 on the second side 710. The second side 710 terminates at second 2 and third 3 vertices of the touch sensor 100. The cut location 810 is between the at least one first and second alignment features 410, 446. The touch sensor 100 is adapted to be cut into a smaller size touch sensor along a cut line 800 that extends perpendicular to and intersecting the second side 710 at the cut location. The second cut line 800 may extend across the viewing area 115 of the touch sensor 100. When the touch sensor 100 is cut along the cut line 800, the touch sensor 100 is divided into third and fourth cut portions 100c, 100d. The third cut portion 100c comprises the at least first alignment feature 410 and may be discarded. The fourth cut portion 100d forms a smaller touch sensor having the at least one second alignment feature 446 near a vertex 3b of the smaller touch sensor 100d. The at least one second alignment feature 446 is adapted for aligning the smaller touch sensor 100d to a smaller substrate.

In some embodiments, the touch sensor 100 may be first cut along one of the cut lines 600, 800 and subsequently cut along the other of the cut lines 800, 600. Thus, using one or both cut lines 600, 800, the size of the larger touch sensor 100 may be reduced along the x axis, along the y axis or along both the x and y axes.

As illustrated in FIG. 5, the bus lines 131, 151, 152 may be connected to the electrodes 111, 121, 122 at a longitudinal end of the electrode. In some embodiments, the connection between the bus line and the electrode is made at an edge of the longitudinal end that such that a majority of the bus line 131, 151, 152 is routed over the longitudinal end of the electrode 111, 121, 122 to which it is connected. For example, in some embodiments, the bus line 131, 151, 152 is connected to the electrode 111, 121, 122 such that the bus line 131, 151, 152 is routed over more than 50%, more than 75%, more than 95% of the longitudinal end. This connection configuration provides for severing the bus line's connection to the electrode when the touch sensor is cut through that electrode. In some embodiments, the connection between the bus line and the electrode may be made at the edge of the longitudinal end that is furthermost from the connection

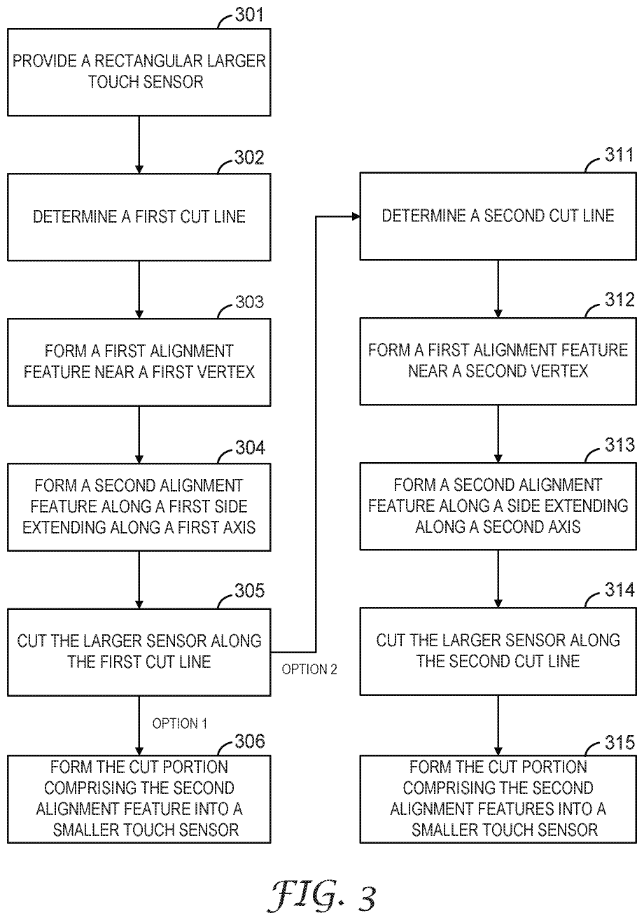

The flow diagram of FIG. 3 illustrates processes of making a rectangular smaller touch sensor from a rectangular larger touch sensor in accordance with some embodiments. The left side of FIG. 3 illustrates processes for a first option that involves reducing the size of the rectangular larger touch sensor along a first axis, e.g., the x-axis. The right side of FIG. 3 illustrates additional processes for a second option that involves additionally reducing the rectangular larger touch sensor along a second axis, e.g., the y-axis.

Starting with 301 a rectangular larger touch sensor, a location of a first cut line is determined 302. The first cut line may extend across a viewing area of the larger touch sensor, orthogonally intersecting a first side of the larger touch sensor at a first cut location. The first side terminates at first and second vertices of the larger touch sensor. A first alignment feature is formed 303 at a first vertex of the larger touch sensor. The first alignment feature is configured to align the larger touch sensor to a larger substrate.

A second alignment feature is formed 304 along the first side of the larger touch sensor and near the first cut location opposite the first alignment feature at the first vertex. The larger touch sensor is cut 305 along a first cut line that lies along a first axis, e.g., the y-axis, into multiple cut portions. The first cut portion comprising the first alignment feature near the first vertex may be discarded. According to option 1, the second cut portion comprising the second alignment feature disposed along the first side is formed 306 into a touch sensor that is smaller than the larger touch sensor. The second alignment feature disposed along the first side is located at a vertex of the smaller touch sensor and is configured to align the smaller touch sensor with a smaller substrate.

Option 2 illustrates processes for cutting the larger touch sensor along two axes, e.g., both the x and y axes. A second cut line lying along an axis, e.g., the x-axis, perpendicular to the first cut line, is determined 311. The second cut line extends across the viewing area of the larger touch sensor and orthogonally intersects a second side of the larger touch sensor at a second cut location. The second side may be oriented orthogonally to the first side. The second side terminates at the second and third vertices of the larger touch sensor. A first alignment feature is formed 312 at the third vertex of the larger touch sensor. The first alignment feature at the third vertex is configured to align the larger touch sensor to the larger substrate. A second alignment feature is formed 313 along the second side near the second cut location opposite the first alignment feature at the third vertex. The portion of the larger touch sensor that was cut along the first cut line is additionally cut 314 along the second cut line multiple cut portions. The cut portion comprising the first alignment feature at the third vertex may be discarded. The cut portion comprising the second alignment feature along the first side and the second alignment feature along the second side is formed 315 into a smaller touch sensor. The second alignment feature disposed along the second side is located at a vertex of the smaller touch sensor and is configured to align the smaller touch sensor with a smaller substrate.

After the larger touch sensor is cut into a smaller touch sensor along one or more axes, the smaller touch sensor includes features that are not present in the larger touch sensor. The second alignment features previously discussed may be used to align the smaller touch sensor with a substrate, e.g., a flexible substrate.

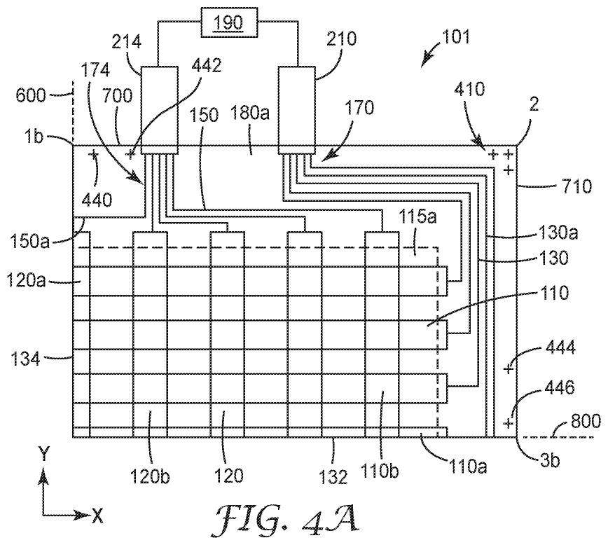

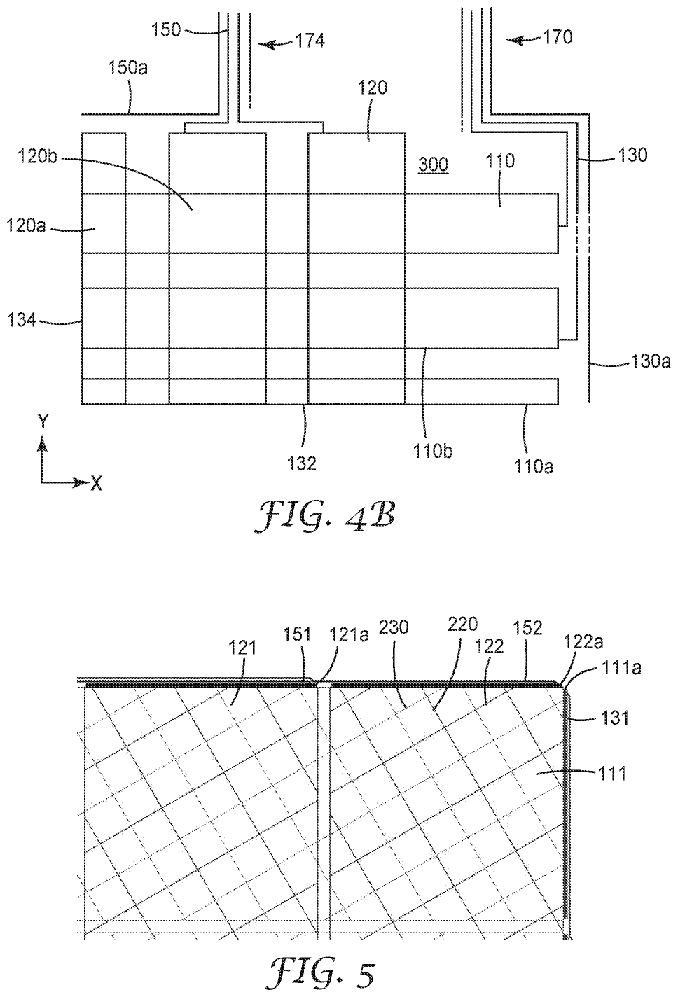

According to some embodiments, the smaller touch sensor includes at least one electrode that is not connected to the bus lines that connect the electrodes to the controller. The embodiment described in conjunction with FIGS. 4A is directed to smaller touch sensor 101 formed from a larger touch sensor that has been cut down both the x and y-axes. FIG. 4B provides a more detailed view of a portion of the touch sensor 101. FIGS. 4A and 4B illustrate the concepts of the embodiments based on a touch sensor that has been cut down along two axes, x and y. However, it will be appreciated that in some embodiments, as previously discussed in connection with FIG. 3, the cut down touch sensor may be cut down along only one axis.

Turning again to FIGS. 4A and 4B, a larger touch sensor has been cut along cut lines 600, 800 to form a cut size touch sensor 101. The touch sensor 101 includes a plurality of spaced apart electrically conductive first electrodes 110, 110a, 110b extending along a first direction, shown as the x direction in FIGS. 4A and 4B, and a plurality of spaced apart electrically conductive second electrodes 120, 120a, 120b extending along a different second direction, shown as the y direction in FIGS. 4A and 4B. The first and second directions may be orthogonal to each other, but need not be orthogonal in some embodiments. The first and second electrodes 110, 110a, 110b, 120, 120a, 120b may be optically transparent.

As illustrated in FIG. 5, in some embodiments, each of the first and second electrodes may comprise a metal mesh 220, 230. FIG. 5 shows one first electrode 111 and two second electrodes 121, 122.

As illustrated in FIG. 5, in some embodiments the bus line 131 corresponding to the first electrode 111 electrically connects to the first electrode 111 at an edge 111a of the longitudinal end of electrode 111. Bus lines 151, 152 corresponding respectively to the second electrodes 121 and 122 electrically connect to the bus lines 151, 152 at the edges 121a, 122a of the longitudinal ends of electrodes 121, 122. In some embodiments, the bus lines are connected to the electrode at the edge of the longitudinal end that is furthermost from the connection area. Connecting the bus lines at the edges of the longitudinal ends of the electrodes ensures that if the touch sensor is cut down through an electrode, e.g., through approximately the center of an electrode, the bus line connected to that electrode will be severed by the cut so that the cut electrode cannot be connected for touch sensing. Thus, the electrodes that are connected for use in touch sensing have substantially the same width. This simplifies the controller programming for touch location determination.

Returning to FIGS. 4A and 4B, the touch sensor 101 includes plurality of electrically conductive bus lines 130, 130a, 150, 150a. The bus lines 130, 130a, 150, 150a may also comprise a metal mesh in some implementations. Each bus line 130, 130a, 150, 150a corresponds to a first or second electrode 110, 110a, 110b, 120, 120a, 120b. A first end of each bus line 130a, 130, 150a, 150 terminates at a connection region 170, 174 at a periphery 180a of the touch sensor 101 for connection to a controller 190. The periphery 180a surrounds an optically transparent viewing area 115a of the touch sensor 101. At least the portion of the periphery 180a that includes the bus lines 130a, 130, 150a, 150 may be optically opaque.

An opposite second end of each bus line 130, 150, except for at least one bus line 130a, 150a, terminates at and makes contact with a corresponding first or second electrode 110, 110b, 120, 120b. The opposite second end of the bus line 130a terminates near, but not making contact with, a longitudinal end of a corresponding first 110a electrode. The opposite second end of the bus line 150a terminates near, but not making contact with, a longitudinal end of a second 120a electrode. The first electrode 110a that is not connected to the second end of its corresponding bus line 130a is narrower than an adjacent first electrode 110b that is connected to the second end of its corresponding bus line 130. A corresponding second electrode 120a that is not connected the second end of its corresponding bus line 150a is narrower than an adjacent second electrode 120b that is connected to the second end of its corresponding bus line 150.

In some embodiments, the first and second electrodes 110, 110a, 110b, 120, 120a, 120b are disposed on a flexible substrate 300. The first electrode 110a corresponding to truncated bus line 130a extends to a first edge 132 of the flexible substrate 300. The second electrode 120a corresponding to truncated bus line 150a extends to a different edge 134 of flexible substrate 300.

In some embodiments, electrical connection between the first ends of one or more of the bus lines 130, 150 and the controller 190 at one or more of the connection regions 170, 174 may be made via one or more flexible circuits 210, 214 assembled to the connection region 170, 174. In some embodiments, electrical connection between the first ends of one more of the bus lines 130, 150 and the controller 190 at one or more of the connection regions 170, 174 may be made via a flexible circuit 210, 214 that is integral to and extends from the flexible substrate 300 at the connection region 170, 174.

According to some embodiments, after the larger touch sensor 100 is cut into a smaller touch sensor 101 along one or more axes, the smaller touch sensor 101 includes at least one electrode 110a, 120a that extends to an edge of the flexible substrate 300. As illustrated in FIG. 4A, the cut down touch sensor 101 includes a flexible substrate having first 132 and second 134 edges extending along different respective first and second directions. The first and second directions are represented as x and y directions, respectively, in FIGS. 4A and 4B. The plurality of spaced apart electrically conductive first electrodes 110, 110a, 110b disposed on the flexible substrate 300 extend longitudinally along the first direction. The first electrode 110a nearest the first edge 132 of the substrate 300 is narrower than the adjacent first electrode 110b and the other first electrodes 110. The nearest electrode 110a to the first edge 132 extends widthwise to the first edge 132. The plurality of spaced apart electrically conductive second electrodes 120, 120a, 120b disposed on the flexible substrate 300 extend longitudinally along the second direction. Second electrode 120a nearest the second edge 134 of the substrate 300 is narrower than the adjacent second electrode 120b and the other second electrodes 120. The second electrode 120a nearest the second edge 134 extends widthwise to the second edge 134. When the touch sensor is assembled into a touch sensitive device, such as a touch sensitive display, at least one of the first electrode 110a nearest the first edge 132 and/or the second electrode 120a nearest the second edge 134 is disposed in an opaque periphery touch sensor. For example, the opaque periphery of the touch sensor may be covered by a bezel of the assembled touch sensitive device, e.g., a touch sensitive display. As previously discussed, the touch sensor 101 includes a plurality of electrically conductive bus lines 130, 130a 150, 150a, each bus line 130, 130a corresponding to a first electrode 110, 110a, 110b or a second electrode 120, 120a, 120b. The bus line 130a corresponding to the first electrode 110a nearest the first edge 132 terminates near, but does not make contact with the first electrode 110a. Similarly, the bus line 150a corresponding to the second electrode 120a nearest the second edge 134 terminates near, but does not make contact with the second electrode 120a.

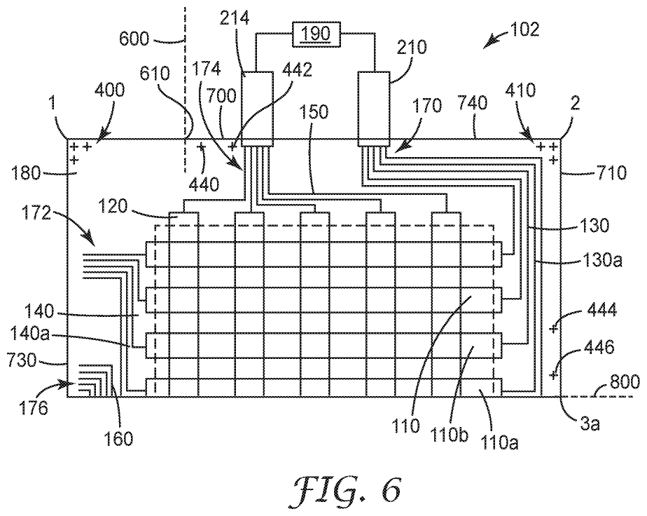

In some embodiments, a touch sensitive device incorporating the cut down touch sensor includes a flexible circuit connected to one connection region but not another connection region. The touch sensitive device is configured to detect a location of a touch applied to the touch sensor by detecting a change in a coupling capacitance near the touch location. For example, consider the full size touch sensor 100 shown in FIG. 1. The full size touch sensor 100 may be cut down only along the second cut line 800 that extends along x-axis without cutting along the first cut line 600 that extends along the y-axis. Cutting touch sensor 100 along only the x-axis leaves a smaller touch sensor 102 with idle connection regions 172, 176 as illustrated in FIG. 6.

Referring to FIG. 6 a touch sensitive device 600 that incorporates the cut down touch sensor 102 includes a plurality of spaced apart electrically conductive first electrodes 110, 110a, 110b extending along the x direction and a plurality of spaced apart electrically conductive second electrodes 120 extending along the y direction. A plurality of electrically conductive first bus lines 130, 130a corresponds to the first electrodes 110, 110a, 110b. First bus lines 130 electrically connect a first end of each of the first electrodes 110, 110b to a first connection region 170 at a periphery of the touch sensor 101 for connection to a controller 190. Bus line 130a is truncated by the cut and does not connect to its corresponding first electrode 110a.

A plurality of electrically conductive third bus lines 140, 140a corresponds to the first electrodes 110, 110a, 110b. A plurality of electrically conductive third bus lines 140 electrically connects an opposite second end of each first electrode 110, 110a, 110b to a different third connection region 172 at the periphery of the touch sensor 102 for connection to a controller. Bus line 140a is truncated by the cut and does not connect to its corresponding first electrode 110a. A flexible circuit 210 is connected to the first 170, but not the third 172, connection region.

In some embodiments, the flexible circuit 210 that is connected to the first connection region 170 is assembled to the touch sensor 102 at the first connection region 170. In some embodiments, the flexible circuit 210 that is connected to the first connection region 170 is integral to and extends from the touch sensor 102 at the first connection region 170.

A plurality of electrically conductive second bus lines 150 corresponds to the second electrodes 120. Second bus lines 150 electrically connect a first end of each second electrode 120 to a second connection region 174 at a periphery of the touch sensor 102 for connection to a controller 190. A plurality of electrically conductive fourth bus lines 160 corresponds to the second electrodes 120 and terminates at a fourth connection region for connection to a controller. A flexible circuit 214 is connected to the second 174, but not the fourth 176, connection region.

In some embodiments, the flexible circuit 210 that is connected to the first connection region 170 is assembled to the touch sensor 102 at the first connection region 170. In some embodiments, the flexible circuit 210 that is connected to the first connection region 170 is integral to and extends from the touch sensor 102 at the first connection region 170. In some embodiments, the flexible circuit 210 that is connected to the first connection region 170 is assembled to the touch sensor 102 at the first connection region 170. Similarly, in some embodiments, the flexible circuit 214 that is connected to the second connection region 174 is integral to and extends from the touch sensor 102 at the second connection region 174.

As illustrated in FIG. 6, the first and third connection regions 170, 172 may be located along adjacent edges 700, 740 of the touch sensor 102. Alternatively, the first and third connection regions may be disposed along a same edge or along opposite edges of the touch sensor. According to some implementations, the first electrodes 110, 110a, 110b are optically transparent and/or the first and second bus lines 130, 130a, 140 are optically opaque.

As illustrated in FIG. 6, the second and fourth connection regions 174, 176 may be located along adjacent edges 700, 740 of the touch sensor 102. Alternatively, the first and third connection regions may be disposed along a same edge or along opposite edges of the touch sensor. According to some implementations, the first electrodes 120 are optically transparent and/or the second and fourth bus lines 150, 160 are optically opaque.

As illustrated in FIG. 6, the first 170 and second 174 connection regions may be located along a same edge 700 of the touch sensor 102. Alternatively, the first and second connection regions may be located along adjacent edges or along opposite edges of the touch sensor.

Items disclosed herein include:

Item 1. A capacitive touch sensor, comprising:

a plurality of spaced apart electrically conductive first electrodes extending along a first direction;

a plurality of spaced apart electrically conductive second electrodes extending along a different second direction; and

a plurality of electrically conductive bus lines, each bus line corresponding to a first or second electrode, a first end of each bus line terminating at a connection region at a periphery of the touch sensor for connection to a controller, an opposite second end of each bus line, except for at least one bus line, terminating at and making contact with a corresponding first or second electrode, the opposite second end of the at least one bus line terminating near, but not making contact with, a longitudinal end of a corresponding first or second electrode.

Item 2. The capacitive touch sensor of item 1, wherein the connection between the first ends of the bus lines to a controller at the connection region is made via a flexible circuit assembled to the connection region.
Item 3. The capacitive touch sensor of item 1, wherein the connection between the first ends of the bus lines to a controller at the connection region is made via a flexible circuit integral to and extending from the touch sensor at the connection region.
Item 4. The capacitive touch sensor of any of items 1 through 3, wherein each first and second electrode is optically transparent.
Item 5. The capacitive touch sensor of any of items 1 through 4, wherein the first and second directions are orthogonal to each other.
Item 6. The capacitive touch sensor of any of items 1 through 5, wherein each of the first and second electrodes comprises a metal mesh.
Item 7. The capacitive touch sensor of any of items 1 through 6, wherein each bus line comprises a metal mesh.
Item 8. The capacitive touch sensor of any of items 1 through 7, wherein the at least one bus line comprises first and second bus lines in the plurality of bus lines, the opposite second end of the first bus line terminating near, but not making contact with, a longitudinal end of a corresponding first electrode, the opposite second end of the second bus line terminating near, but not making contact with, a longitudinal end of a corresponding second electrode.
Item 9. The capacitive touch sensor of item 8, wherein the corresponding first electrode is narrower than an adjacent first electrode, and the corresponding second electrode is narrower than an adjacent second electrode.
Item 10. The capacitive touch sensor of item 8, wherein the first and second electrodes are disposed on a flexible substrate, the corresponding first electrode extending to a first edge of the substrate, the corresponding second electrode extending to a different edge of the flexible substrate.
Item 11. The capacitive touch sensor of any of items 1 through 10, wherein at least a portion of the periphery is optically opaque and at least partially surrounds an optically transparent viewing area.
Item 12. A capacitive touch sensor, comprising:

a flexible substrate having first and second edges extending along different respective first and second directions;

a plurality of spaced apart electrically conductive first electrodes disposed on the flexible substrate and extending longitudinally along the first direction, the first electrode nearest the first edge of the substrate being narrower than the rest of the first electrodes and extending widthwise to the first edge; and

a plurality of spaced apart electrically conductive second electrodes disposed on the flexible substrate and extending longitudinally along the second direction.

Item 13. The capacitive touch sensor of item 12, wherein the first electrode nearest the first edge is disposed in an opaque periphery of the touch sensor.
Item 14. The capacitive touch sensor of any of items 12 through 13, wherein the second electrode nearest the second edge of the substrate is narrower than the rest of the second electrodes and extends widthwise to the second edge.
Item 15. The capacitive touch sensor of any of items 12 through 14, wherein the second electrode nearest the second edge is disposed in an opaque periphery of the touch sensor.
Item 16. The capacitive touch sensor of any of items 12 through 15, wherein each first and second electrode is optically transparent.
Item 17. The capacitive touch sensor of any of items 12 through 16, further comprising a plurality of electrically conductive bus lines, each bus line corresponding to a first electrode, the bus line corresponding to the first electrode nearest the first edge terminating near, but not making contact with the first electrode.
Item 18. A capacitive touch sensor, comprising:

a touch sensitive viewing area;

a border area surrounding the touch sensitive viewing area and having an outermost polygonal perimeter comprising a plurality of sides and vertices;

a plurality of spaced apart electrically conductive first electrodes disposed in the touch sensitive viewing area and extending along a first direction;

a plurality of spaced apart electrically conductive second electrodes disposed in the touch sensitive viewing area and extending along a different second direction;

a plurality of electrically conductive bus lines disposed in the border area for electrically coupling the pluralities of the first and second electrodes to a controller;

at least one first alignment feature within the border area near each of at least three vertices of the polygonal perimeter for aligning the touch sensor to a substrate; and

at least one second alignment feature within the border area near each of at least one side of the polygonal perimeter and away from the vertices corresponding to the side.

Item 19. The capacitive touch sensor of item 18, wherein:

the border area has an outermost rectangular perimeter comprising four sides and four vertices;

at least one first alignment feature is disposed within the border area near each vertex of the polygonal perimeter; and

at least one second alignment feature is disposed within the border area near each of two adjacent sides of the polygonal perimeter and away from the vertices corresponding to the side.

Item 20. The capacitive touch sensor of any of items 18 through 19, wherein each first and second electrode is optically transparent.
Item 21. The capacitive touch sensor of any of items 18 through 20 wherein the at least one first alignment feature is for aligning the touch sensor to a substrate, the substrate being optically transparent at least in a region corresponding to the touch sensitive viewing area.
Item 22. The capacitive touch sensor of any of items 18 through 21, wherein a first side of the polygonal perimeter has the at least one first alignment feature near a longitudinal end of the first side and the at least one second alignment feature near a cut location on the first side, the cut location between the at least one first and second alignment features, the touch sensor adapted to be cut into a smaller size touch sensor along a cutline perpendicular to and intersecting the first side at the cut location, such that when the touch sensor is cut along the cutline, the touch sensor is divided into first and second cut portions, the second cut portion forms a smaller touch sensor having the at least second alignment feature near a vertex of the smaller touch sensor, the at least one second alignment feature adapted for aligning the smaller touch sensor to a smaller substrate.
Item 23. The capacitive touch sensor of item 18, wherein each electrically conductive bus line is electrically connected to a corresponding first or second electrode at an edge of a longitudinal end of the corresponding electrode such that the bus line is routed over a majority of the longitudinal end.
Item 24. A capacitive touch sensitive device comprising:

a touch sensor, comprising:
a plurality of spaced apart electrically conductive first electrodes extending along a first direction;
a plurality of electrically conductive first bus lines electrically connecting a first end of each first electrode to a first connection region at a periphery of the touch sensor for connection to a controller;
a plurality of electrically conductive third bus lines for electrically connecting an opposite second end of each first electrode to a different third connection region at the periphery of the touch sensor for connection to a controller; and
a flexible circuit connected to the first, but not the third, connection region, wherein the touch sensitive device is configured to detect a location of a touch applied to the touch sensor by detecting a change in a coupling capacitance near the touch location.
   Item 25. The capacitive touch sensitive device of item 24, wherein the flexible circuit that is connected to the first connection region is assembled to the touch sensor at the first connection region.
   Item 26. The capacitive touch sensitive device of any of items 24 through 25, wherein the flexible circuit that is connected to the first connection region is integral to and extends from the touch sensitive device at the first connection region.
   Item 27. The capacitive touch sensitive device of any of items 24 through 26, wherein the first and third connection regions are along a same edge of the touch sensor.
   Item 28. The capacitive touch sensitive device of any of items 24 through 26, wherein the first and third connection regions are along adjacent edges of the touch sensor.
   Item 29. The capacitive touch sensitive device of any of items 24 through 26, wherein the first and third connection regions are along opposite edges of the touch sensor.
   Item 30. The capacitive touch sensitive device of any of items 24 through 29, wherein the first electrodes are optically transparent and the first and third bus lines are optically opaque.
   Item 31. The capacitive touch sensitive device of any of items 24 through 30, wherein the touch sensor further comprises:

a plurality of spaced apart electrically conductive second electrodes extending along a different second direction;

a plurality of electrically conductive second bus lines electrically connecting a first end of each second electrode to a second connection region, different than the first and third connection regions, at the periphery of the touch sensor for connection to a controller; and

a plurality of electrically conductive fourth bus lines for electrically connecting an opposite second end of each second electrode to a fourth connection region, different than the first, second, and third connection regions, at the periphery of the touch sensor for connection to the controller.

Item 32. The capacitive touch sensitive device of item 31, wherein the second and fourth connection regions are along a same edge of the touch sensor.
Item 33. The capacitive touch sensitive device of item 31, wherein the second and fourth connection regions are along adjacent edges of the touch sensor.
Item 34. The capacitive touch sensitive device of item 31, wherein the second and fourth connection regions are along opposite edges of the touch sensor.
Item 35. The capacitive touch sensitive device of item 31, further comprising a flexible circuit connected to the second, but not the fourth, connection region.
Item 36. The capacitive touch sensitive device of item 31, wherein the first and second connection regions are along a same edge of the touch sensor.
Item 37. The capacitive touch sensitive device of item 31, wherein the first and second connection regions are along adjacent edges of the touch sensor.
Item 38. The capacitive touch sensitive device of item 31, wherein the first and second connection regions are along opposite edges of the touch sensor.
Item 39. A method of making a rectangular smaller touch sensor from a rectangular larger touch sensor, comprising:

providing a rectangular larger touch sensor;

determining a first cutline extending across a viewing area of the larger touch sensor and orthogonally intersecting a first side of the larger touch sensor at a first cut location, the first side terminating at first and second vertices of the larger touch sensor;

forming a first alignment feature at a first vertex of the larger touch sensor, the first alignment feature configured to align the larger touch sensor to a larger substrate;

forming a second alignment feature near the first cut location opposite the first alignment feature;

cutting the larger sensor along the first cutline into multiple cut portions;

forming the cut portion comprising the second alignment feature into a smaller touch sensor, the second alignment feature being at a vertex of the smaller touch sensor and configured to align the smaller touch sensor with a smaller substrate.

Item 40. The method of item 39, further comprising discarding the cut portion comprising the first alignment feature.
Item 41. The method of any of items 39 through 40, wherein forming the cut portion comprising the second alignment feature into the smaller touch sensor comprises:

determining a second cutline extending across the viewing area of the larger touch sensor and orthogonally intersecting a second side, orthogonal to the first side, of the larger touch sensor at a second cut location, the first side terminating at the second and a third vertices of the larger touch sensor;

forming a third alignment feature at the third vertex of the larger touch sensor, the third alignment feature configured to align the larger touch sensor to the larger substrate; forming a fourth alignment feature near the second cut location opposite the third alignment feature;

cutting the larger sensor along the second cutline into multiple cut portions; and

forming the cut portion comprising the second and fourth alignment features into a smaller touch sensor, the fourth alignment feature being at a vertex of the smaller touch sensor and configured to align the smaller touch sensor with the smaller substrate.

Item 42. The method of item 41, further comprising discarding the cut portion comprising the third alignment feature.

Various modifications and alterations of this invention will be apparent to those skilled in the art and it should be understood that this scope of this disclosure is not limited to the illustrative embodiments set forth herein. For example, the reader should assume that features of one disclosed embodiment can also be applied to all other disclosed embodiments unless otherwise indicated.

1-12. (canceled)

13. A capacitive touch sensor, comprising:
a plurality of spaced apart electrically conductive first electrodes extending along a first direction;
a plurality of spaced apart electrically conductive second electrodes extending along a different second direction; and
a plurality of electrically conductive bus lines, each bus line corresponding to a first or second electrode, a first end of each bus line terminating at a connection region at a periphery of the touch sensor for connection to a controller, an opposite second end of each bus line, except for at least one bus line, terminating at and making contact with a corresponding first or second electrode, the opposite second end of the at least one bus line terminating near, but not making contact with, a longitudinal end of a corresponding first or second electrode.

14. The capacitive touch sensor of claim 13, wherein each of the first and second electrodes comprises a metal mesh.

15. The capacitive touch sensor of claim 13, wherein each bus line comprises a metal mesh.

16. The capacitive touch sensor of claim 13, wherein the at least one bus line comprises first and second bus lines in the plurality of bus lines, the opposite second end of the first bus line terminating near, but not making contact with, a longitudinal end of a corresponding first electrode, the opposite second end of the second bus line terminating near, but not making contact with, a longitudinal end of a corresponding second electrode.

17. The capacitive touch sensor of claim 16, wherein the corresponding first electrode is narrower than an adjacent first electrode, and the corresponding second electrode is narrower than an adjacent second electrode.

18. The capacitive touch sensor of claim 13, wherein at least a portion of the periphery is optically opaque and at least partially surrounds an optically transparent viewing area.

19. A capacitive touch sensor, comprising:
a flexible substrate having first and second edges extending along different respective first and second directions;
a plurality of spaced apart electrically conductive first electrodes disposed on the flexible substrate and extending longitudinally along the first direction, the first electrode nearest the first edge of the substrate being narrower than the rest of the first electrodes and extending widthwise to the first edge; and
a plurality of spaced apart electrically conductive second electrodes disposed on the flexible substrate and extending longitudinally along the second direction.

20. The capacitive touch sensor of claim 19, wherein the first electrode nearest the first edge is disposed in an opaque periphery of the touch sensor.

21. The capacitive touch sensor of claim 19, wherein the second electrode nearest the second edge of the substrate is narrower than the rest of the second electrodes and extends widthwise to the second edge.

22. The capacitive touch sensor of claim 19, further comprising a plurality of electrically conductive bus lines, each bus line corresponding to a first electrode, the bus line corresponding to the first electrode nearest the first edge terminating near, but not making contact with the first electrode.

23. A capacitive touch sensor, comprising:
a touch sensitive viewing area;
a border area surrounding the touch sensitive viewing area and having an outermost polygonal perimeter comprising a plurality of sides and vertices;
a plurality of spaced apart electrically conductive first electrodes disposed in the touch sensitive viewing area and extending along a first direction;
a plurality of spaced apart electrically conductive second electrodes disposed in the touch sensitive viewing area and extending along a different second direction;
a plurality of electrically conductive bus lines disposed in the border area for electrically coupling the pluralities of the first and second electrodes to a controller;
at least one first alignment feature within the border area near each of at least three vertices of the polygonal perimeter for aligning the touch sensor to a substrate; and
at least one second alignment feature within the border area near each of at least one side of the polygonal perimeter and away from the vertices corresponding to the side.

24. The capacitive touch sensor of claim 23, wherein:
the border area has an outermost rectangular perimeter comprising four sides and four vertices;
at least one first alignment feature is disposed within the border area near each vertex of the polygonal perimeter; and
at least one second alignment feature is disposed within the border area near each of two adjacent sides of the polygonal perimeter and away from the vertices corresponding to the side.

25. The capacitive touch sensor of claim 23, wherein a first side of the polygonal perimeter has the at least one first alignment feature near a longitudinal end of the first side and the at least one second alignment feature near a cut location on the first side, the cut location between the at least one first and second alignment features, the touch sensor adapted to be cut into a smaller size touch sensor along a cutline perpendicular to and intersecting the first side at the cut location, such that when the touch sensor is cut along the cutline, the touch sensor is divided into first and second cut portions, the second cut portion forms a smaller touch sensor having the at least second alignment feature near a vertex of the smaller touch sensor, the at least one second alignment feature adapted for aligning the smaller touch sensor to a smaller substrate.

26. A capacitive touch sensitive device comprising:
a touch sensor, comprising:
a plurality of spaced apart electrically conductive first electrodes extending along a first direction;
a plurality of electrically conductive first bus lines electrically connecting a first end of each first electrode to a first connection region at a periphery of the touch sensor for connection to a controller;
a plurality of electrically conductive third bus lines for electrically connecting an opposite second end of each first electrode to a different third connection region at the periphery of the touch sensor for connection to a controller; and
a flexible circuit connected to the first, but not the third, connection region, wherein the touch sensitive device is configured to detect a location of a touch applied to the touch sensor by detecting a change in a coupling capacitance near the touch location.

27. The capacitive touch sensitive device of claim 26, wherein the flexible circuit that is connected to the first connection region is assembled to the touch sensor at the first connection region.

28. The capacitive touch sensitive device of claim 26, wherein the first electrodes are optically transparent and the first and third bus lines are optically opaque.

29. The capacitive touch sensitive device of claim 26, wherein the touch sensor further comprises:
a plurality of spaced apart electrically conductive second electrodes extending along a different second direction;
a plurality of electrically conductive second bus lines electrically connecting a first end of each second electrode to a second connection region, different than the first and third connection regions, at the periphery of the touch sensor for connection to a controller; and
a plurality of electrically conductive fourth bus lines for electrically connecting an opposite second end of each second electrode to a fourth connection region, different than the first, second, and third connection regions, at the periphery of the touch sensor for connection to the controller.

30. A method of making a rectangular smaller touch sensor from a rectangular larger touch sensor, comprising:
providing a rectangular larger touch sensor;
determining a first cutline extending across a viewing area of the larger touch sensor and orthogonally intersecting a first side of the larger touch sensor at a first cut location, the first side terminating at first and second vertices of the larger touch sensor;
forming a first alignment feature at a first vertex of the larger touch sensor, the first alignment feature configured to align the larger touch sensor to a larger substrate;
forming a second alignment feature near the first cut location opposite the first alignment feature;
cutting the larger sensor along the first cutline into multiple cut portions;
forming the cut portion comprising the second alignment feature into a smaller touch sensor, the second alignment feature being at a vertex of the smaller touch sensor and configured to align the smaller touch sensor with a smaller substrate.

31. The method of claim 30, further comprising discarding the cut portion comprising the first alignment feature.

32. The method of claim 30, wherein forming the cut portion comprising the second alignment feature into the smaller touch sensor comprises:
determining a second cutline extending across the viewing area of the larger touch sensor and orthogonally intersecting a second side, orthogonal to the first side, of the larger touch sensor at a second cut location, the first side terminating at the second and a third vertices of the larger touch sensor;
forming a third alignment feature at the third vertex of the larger touch sensor, the third alignment feature configured to align the larger touch sensor to the larger substrate;
forming a fourth alignment feature near the second cut location opposite the third alignment feature;
cutting the larger sensor along the second cutline into multiple cut portions; and
forming the cut portion comprising the second and fourth alignment features into a smaller touch sensor, the fourth alignment feature being at a vertex of the smaller touch sensor and configured to align the smaller touch sensor with the smaller substrate.
